(19) United States
(12) Patent Application Publication
(10) Pub. No.: US 2007/0060005 A1
(43) Pub. Date: Mar. 15, 2007

(54) INSULATION PRODUCT FROM ROTARY AND TEXTILE INORGANIC FIBERS WITH IMPROVED BINDER COMPONENT AND METHOD OF MAKING SAME

(75) Inventors: Alain Yang, Villanova, PA (US); Mark S. Trabbold, Harleysville, PA (US)

Correspondence Address: DUANE MORRIS, LLP;IP DEPARTMENT, 30 SOUTH 17TH STREET, PHILADELPHIA, PA, 19103-4196, US

(73) Assignee: CERTAINTEED CORPORATION, Valley Forge, PA (US)

(21) Appl. No.: 11/554,906

(22) Filed: Oct. 31, 2006

Related U.S. Application Data
(63) Continuation-in-part of application No. 10/807,058, filed on Mar. 23, 2004.
Application No. 10/807,058 is a continuation-in-part of application No. 09/946,474, filed on Sep. 6, 2001, now abandoned.
Application No. 10/807,058 is a continuation-in-part of application No. 09/946,476, filed on Sep. 6, 2001, now abandoned.
Application No. 10/807,058 is a continuation-in-part of application No. 10/689,858, filed on Oct. 22, 2003, now abandoned.
Application No. 10/807,058 is a continuation-in-part of application No. 10/766,052, filed on Jan. 28, 2004.
Application No. 10/807,058 is a continuation-in-part of application No. 10/781,994, filed on Feb. 19, 2004.
Application No. 10/807,058 is a continuation-in-part of application No. 10/782,275, filed on Feb. 19, 2004.
Application No. 10/782,275 is a continuation-in-part of application No. 09/946,476, filed on Sep. 6, 2001, now abandoned.
Application No. 10/782,275 is a continuation-in-part of application No. 10/689,858, filed on Oct. 22, 2003, now abandoned.
Application No. 10/782,275 is a continuation-in-part of application No. 10/766,052, filed on Jan. 28, 2004.

(51) Int. Cl. B32B 5/02; B32B 1/04; B27N 3/00; B32B 27/04; D04H 1/00; B32B 17/02; D04H 13/00

(52) U.S. Cl. 442/180; 442/60; 442/120; 442/331; 442/342; 442/348; 428/74; 264/109; 264/122

(57) ABSTRACT

An insulation product includes a fibrous web of first fibers, rotary glass fibers, and textile glass fibers. A binder is blended with the fibrous web. The binder bonds the fibers together to form the insulation product. The binder includes a thermoplastic binder component and a powdered binder component.

### CROSS-REFERENCE TO RELATED APPLICATIONS

The present application is a continuation-in-part of and claims priority to copending U.S. patent application Ser. No. 10/807,058, entitled “Insulation Product from Rotary and Textile Inorganic Fibers and Thermoplastic Fibers,” filed Mar. 23, 2004, which is a continuation-in-part of the following U.S. patent applications: U.S. patent application Ser. No. 09/946,474, filed on Sep. 6, 2001; U.S. patent application Ser. No. 09/946,476, filed on Sep. 6, 2001; U.S. patent application Ser. No. 10/689,858, filed on Oct. 22, 2003; U.S. patent application Ser. No. 10/766,052 filed on Jan. 18, 2004; U.S. patent application Ser. No. 10/781,994 filed on Feb. 19, 2004; and U.S. patent application Ser. No. 10/782,275, filed Feb. 19, 2004, the entirety of each of which is hereby incorporated by reference herein.

The present application is also a continuation-in-part and claim priority to copending U.S. patent application Ser. No. 10/782,275, entitled “Inorganic Fiber Insulation Made from Glass Fibers and Polymer Bonding Fibers,” filed Feb. 19, 2004, which is a continuation-in-part of the following U.S. patent applications: U.S. patent application Ser. No. 09/946,476, filed on Sep. 6, 2001; U.S. patent application Ser. No. 10/689,858, filed on Oct. 22, 2003; and U.S. patent application Ser. No. 10/766,052, filed on Jan. 28, 2004, the entirety of each of which is hereby incorporated by reference herein.

### FIELD OF THE INVENTION

The present invention relates to fiber glass insulation products and methods of making fiber glass insulation products.

### BACKGROUND OF THE INVENTION

Conventional fiber mats or webs used for thermal and acoustic insulation are made either primarily from textile fibers, or from rotary or flame attenuated fibers. The ToughGard® ductliner manufactured by CertainTeed Corporation of Valley Forge, Pa. is an example of insulation products made primarily from textile fibers. Textile fibers used in thermal and acoustic insulation are typically chopped into segments 2 to 15 cm long and have diameters of greater than 4 microns up to 16 microns. Rotary fibers and flame attenuated fibers are relatively short, with lengths on the order of 1 to 5 cm, and relatively fine, with diameters of 2 to 5 microns. Mats made from textile fibers tend to be stronger and less dusty than those made from rotary fibers or flame attenuated fibers, but are somewhat inferior in insulating properties. Mats made from rotary or flame attenuated fibers tend to have better thermal and acoustic insulation properties than those made from textile fibers, but are inferior in strength.

U.S. Published Patent Application No. 2004/0176003A1 to Yang et al. describes a thermal and acoustical insulation product fabricated from rotary glass fibers, thermoplastic fibers and a small quantity of textile fibers and at least one binder. The textile fibers enhance the mechanical strength of the insulation product.

Still though, further improvements, such as in touch and feel of the insulation product, tensile strength and dust production are desired. Thus, a need exists for new, low cost fiber products with a satisfactory combination of insulation, strength and handling characteristics.

### SUMMARY OF THE INVENTION

An insulation product includes a fibrous web of first fibers, rotary glass fibers, and textile glass fibers. A binder is blended with the fibrous web. The binder bonds the fibers together to form the insulation product. The binder includes a non-powderous thermoplastic binder component and a powdered binder component selected from the group consisting of thermoplastic and thermosetting resinous compositions.

In embodiments, the first fibers are a high-melt temperature core fiber component of a bicomponent fiber, with the low-melt temperature sheath component of the bicomponent fiber providing the plastic binder component upon heating of the fibrous web to cure or melt the powdered binder component between the high-melt and low-melt temperatures.

The insulation product exhibits smooth surfaces and is soft to the touch and feel while producing less dust. The insulation product also exhibits improved thermal performance and increased thickness with lower gram weights, along with increased tensile strength. Excellent binder distribution is also provided.

The above and other features of the present invention will be better understood from the following detailed description of the preferred embodiments of the invention that is provided in connection with the accompanying drawings.

### BRIEF DESCRIPTION OF THE DRAWINGS

The accompanying drawings illustrate preferred embodiments of the invention, as well as other information pertinent to the disclosure, in which:

FIG. 1 is a schematic illustration of a cross-sectional view of an exemplary glass fiber insulation product according to an embodiment of the present invention;

FIG. 2 is an enlarged view of a portion of the glass fiber insulation product of FIG. 1; and

FIG. 3 is a flow chart diagram of a process for fabricating the insulation product according to an embodiment of the present invention.

The features shown in the above referenced drawings are not intended to be drawn to scale nor are they intended to be shown in precise positional relationship. Like reference numbers indicate like elements.

### DETAILED DESCRIPTION OF THE INVENTION

This description of the exemplary embodiments is intended to be read in connection with the accompanying drawings, which are to be considered part of the entire written description. In the description, relative terms such as “lower,” “upper, ” “horizontal,” “vertical,” “above,” “below,” “up,” “down,” “top” and “bottom” as well as derivative thereof (e.g., “horizontally,” “downwardly,” “upwardly,” etc.) should be construed to refer to the orientation as then described or as shown in the drawing under discussion. These relative terms are for convenience of description and do not require that the apparatus be constructed or operated in a particular orientation. Terms concerning attachments, coupling and the like, such as “connected” and “interconnected,” refer to a relationship wherein structures are secured or attached to one another either directly or indirectly through intervening structures, as well as both movable or rigid attachments or relationships, unless expressly described otherwise.

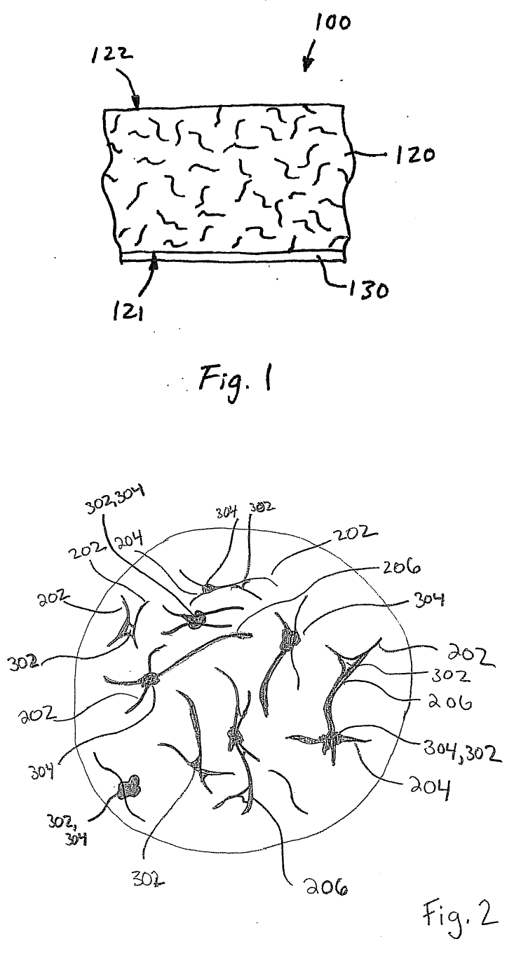

FIG. 1 is a cross-sectional view of a thermal and acoustical insulation product 100, according to a preferred embodiment of the present invention. The insulation product 100 comprises a fibrous insulation mat 120 having a first side 121, a second side 122 and a non-woven facing layer 130 bonded to the first side 121. The fibrous insulation mat 120 has a density of about 16 to 56 kg/m³ (1.0 to 3.5 pounds per cubic feet (pcf)) and preferably about 24 to 48 kg/m³ (1.5 to 3.0 pcf). The gram weight of the fibrous insulation mat 120 is in the range of about 530 to 3750 gm/m² and preferably about 700 to 3300 gm/m². The thickness of the insulation product 100 may be fabricated to be in the range of about 10 to 200 mm (about 0.5 to 8.0 inches) and preferably about 10 to 75 mm (about 0.5 to 3.0 inches). In an exemplary embodiment, the insulation product is a ductliner.

In embodiments, the fibrous web of the insulation mat 120 preferably includes a mixture of three primary structural fiber components bound with a binder, as described below in more detail.

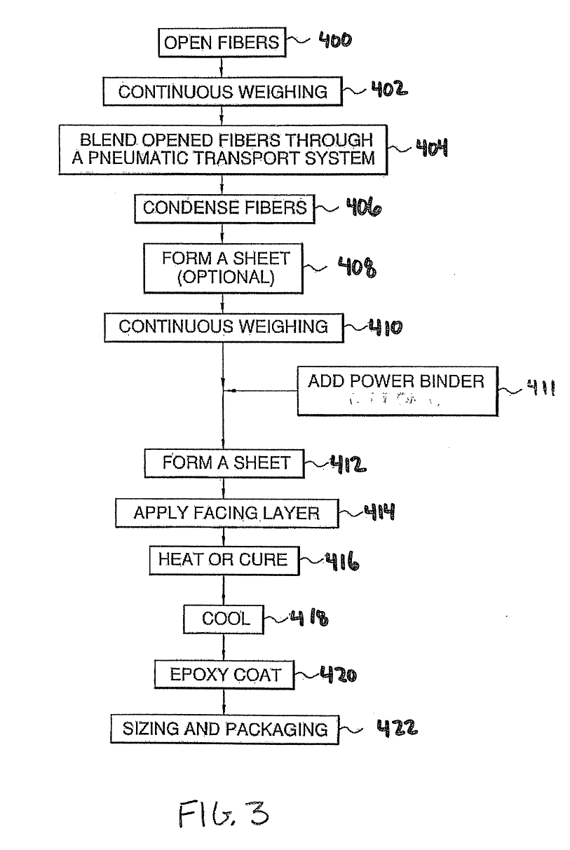

FIG. 2 is a schematic illustration of a more detailed view of the bonded fiber matrix in the insulation product 100 of FIG. 1. The illustration depicts the preferred nature of the resinous bonds in the insulation product of the present invention. The fibrous web includes first component fibers 202, second component fibers 204 and third component fibers 206. The first fibers 202 are preferably the high temperature fiber component of a bicomponent fiber, which remains after the low temperature component is melted.

The three fiber components of the fibrous web are bonded together by two binder components. The binder components themselves may be bound together at portions of the fibrous web. As used herein, a “binder” is a resinous material which can be melted or cured or both to cause fibers to bond to one another. A “binder” is not itself considered a “fiber” that attributes to the structural, thermal or acoustical properties of the insulation product, but it can exhibit a fibrous form, especially before melting or curing. The binder of this invention can be thermoplastic and/or thermosetting resinous compositions.

The first preferred binder component is a resinous binder provided from a powdered resinous binder. When heated and cured (in the case of a thermoset) or melted (in the case of a thermoplastic), this resinous binder forms resin bonds 304 with and between the three fibers 202, 204 and 206 and to the second binder component discussed below. The powdered resinous binder can be a thermoset (like phenolic resin) or thermoplastic resinous composition (like ground or neat nylon fibers). Thermosets typically cross-link when heated. Thermoplastics are more typically considered to melt and then re-solidify and/or re-crystallize to form an adhesion bond.

The second binder component is a non-powderous thermoplastic binder that forms meltbond 302 with and between the fibers 202, 204 and 206. In embodiments, this thermoplastic binder is provided from the low-melting temperature component of a bicomponent fiber. When the fibrous web is heated to above the melting temperature of the low-melting temperature component, the low-melting temperature component (or a substantial portion thereof) substantially, and preferably completely, melts and is free to flow from the high-melting temperature fibrous carrier component, which remains and forms first fibrous component 202. When the web cools, the melted thermoplastic component solidifies and forms thermoplastic bonds 302 with the fibers 202, 204, 206 and with the cured first binder component. Any fibers that intersect with the melted thermoplastic component and the powdered (but now melted and cured) resinous binder are bonded (i.e. first-to-second fibrous components 202, 204; first-to-third fibrous components 202, 206; second-to-third fibrous components 204, 206, first-first fibrous components 202; second-to-second fibrous components 204; and third-to-third fibrous components 206, 206) after the blended fiber mixture is cooled to ambient temperature. The powdered resinous binder forms adhesive bonds 304 between any set of fibers that may be in contact or near each other. The melt bonds 302 formed with the non-powderous melted thermoplastic component supplement the adhesive bonds 304 formed by the resinous binder. At portions of the matrix, bonds with a fiber or between fibers includes a melt bond 302 and adhesive bond 304 (shown as 302, 304 or 304, 302 in FIG. 2) where the two binder components contact or mix.

In a preferred embodiment of the present invention, the fibrous insulation mat 120 may be fabricated from inorganic fibers, such as glass fibers comprising rotary fibers and textile fibers, bicomponent fibers (which act as the source of third component fibers and the thermoplastic binder) and at least one other binder, such as a thermosetting phenolic resin binder. The textile and rotary fibers may be scrap fibers to minimize the raw material cost.

The second fiber 204 is preferably a man-made mineral fiber or natural fiber, preferably rotary fiber from a glass wool production line including virgin and recycled scrap fiber with average diameter from about 2 to 5 microns, and preferably between about 4 and 5 microns. The rotary glass fibers have an average length of less than about 125 mm (about 5 inches) and preferably less than about 75 mm (about 3 inches). In a preferred embodiment of the present invention, at least a portion of the rotary glass fibers may be scrap fibers, such as, for example, scrap building insulation batts or blown insulation fibers. In exemplary embodiments, the rotary fibers are provided to form about 30-70% of the weight of the insulation product when compared to the other primary components (first and third fiber components 202, 206 and binder) described below.

The third fiber 206 is preferably a textile glass fiber, preferably starch or plastic sized. Textile glass fibers, which may preferably be scrap textile fibers, enhance the strength of the final insulation product. The textile fibers may have an average diameter of about 6 to 20 microns, and more preferably 4 to 15 microns, and average fiber length of about 13 to 260 mm (about 0.5 to 10 inches), and preferably between about 38 and 100 mm (about 1.5 to 4 inches). The total textile glass fiber content of the insulation product may be about 30 to 70 wt. % of the fibrous insulation mat 120.

The total glass fiber (rotary and textile) content is preferably greater than about 70 wt. % of the final insulation product, and more preferably greater than about 75 wt. % of the final insulation product, and still more preferably between about 80-90 wt. %, and most preferably between about 85-90 wt. % of the insulation product.

As mentioned above, the source for the first fibrous component 202 is preferably a bicomponent fiber comprising a high-melting temperature fibrous component and a low-melting temperature thermoplastic polymer component. Bicomponent fibers are generally formed when two polymers are extruded from the same spinneret with both polymers contained within the same filament. Bicomponent fibers allow for exploitation of capabilities not existing in either polymer alone. In one embodiment, the bicomponent fibers have a first sheath component portion that surrounds a core material second component portion, but other configurations are certainly contemplated, such as the so-called “side-by-side” configuration where two connected components lie side-by-side or “islands-in-the-sea” fibers where areas of one polymer can be found in the matrix of a second polymer. In some embodiments, cospun fibers, which include a group of filaments of different polymers but a single component per filament, spun from the same spinneret, may be used. “Bicomponent fiber” as used herein means both traditional bicomponent fibers described above and their close relatives, e.g., cospun fibers.

In one embodiment, the first component portion, such as the sheath portion, is formed from a material that has a significantly lower melting point than the second component portion, such as the core material, such that it can be melted as part of the process used to cure the resinous powder binder. When melted and then cooled, the first component portion of each fiber forms a non-fibrous (e.g., randomly shaped) meltbond between the other fibers (i.e., rotary, textile, high-melting temperature fiber component of the bicomponent fiber) and with the fibers of the fibrous web 120. In exemplary embodiments, the high-melting temperature component and low-melting temperature components have melting temperature that differ by at least 50° C., and more preferably by at least 75° C. and most preferably by at least about 100° C. In one embodiment, the melting temperature of the high-melting temperature component is at least about 175° C., and more preferably at least about 220° C., and still more preferably at least about 250° C., whereas the melting temperature of the low-melting temperature component is less than or equal to about 160° C., and more preferably less than or equal to about 135° C., and still more preferably less than or equal to about 120° C.

The first and second component materials may be selected from the group consisting of polyethylene, polypropylene, polyester, polyethylene terephthalate, polybutylene terephthalate, polycarbonate, polyamide, polyphenylene sulfide, polyolefin, PET (polyester) PEN polyester, nylon 6,6 PCT polyester, polypropylene PBT polyester, nylon 6 co-polyamides, polylactic acid polysterene, acetal polyurethane, and soluble copolyester HDPE, LLDPE, etc. The high-melting temperature component need not be a plastic/polymer fiber. In embodiments, the high-melting temperature component may be an inorganic fiber, such a glass fiber. In one embodiment, the first low-melting temperature component portion is polyester (PE) and the second higher melting temperature component portion is polyethylene (PET). In one further embodiment, the melting point of the first component portion (e.g., sheath) is between about 1100 and 1200 Centigrade and the melting point of the second component portion (e.g., core) is above about 2500 Centigrade.

The bicomponent fibers preferably have a length of less than about 260 mm (about 10.0 inches), and more preferably less than about 130 mm (about 5.0 inches), and a density of less than about 5 denier, and more preferably less than about 3 denier.

In one exemplary embodiment, the bicomponent fibers include CELBOND® Type 255 2.0 denier bicomponent fibers available from Invista, Inc. of Wichita, Kans., or alternatively polyethylene or polypropylene fibers. The sheath polymer of the CELBOND® fibers comprises a PE (polyethylene) material having a melting temperature of around 116° C. and the core is formed from a PET (polyester) material having a higher melting temperature than the sheath material. The core melting temperature is about 260° C.

The first binder component for providing adhesive bonds 304 comprises a powdered resinous binder blended with the three fibrous components. The binder may be any thermosetting resin binder commonly used in the industry. Alternatively, thermoplastic powder binders, such as hot melt adhesives selected from nylon, polyethylene, polypropylene or acrylic-based adhesives. A good source of nylon binder is recycled carpet fiber which can be used as a fiber or ground to a fine powder. Whether the resinous binder cures or melts depends on whether the resinous binder is a thermoplastic type or a thermosetting type. In one embodiment, this binder component comprises a powdered phenolic resin binder, such as SD267E from Hexion Specialty Chemicals, Inc. of the Columbus, Ohio, which has a melting temperature of about 89° C. Alternatively, the binder may be a powdered, formaldehyde free or powdered granular plastic resin binder, such as polypropylene product “Mecocene” MF650Y available from Basell USA Inc. of Elkton Md. or no. PP3546G or PP3746G, which have melting points of about 140° C., available from ExxonMobil Chemical Co. of Houston, Tex.

In exemplary embodiments, the bicomponent fibers and powdered resin contribute between about 5-30 wt. % of the insulation product, and more preferably 10-25 wt. %. More specifically, the bicomponent fiber preferably forms about 1-25 wt. %, and more preferably 3-15 wt. %, and most preferably between about 4-8 wt. %. Heavier concentrations of the bicomponent fiber, or replacing the powdered binder completely, are not preferred as they can make the insulation product difficult to cut. With the CELBOND® T255 bicomponent fiber, the weight of the bicomponent fiber is attributed equally to the low-melting temperature component (i.e., sheath) and high-melting temperature component (i.e., core) of the fibers. The powdered binder component is preferably provided in an amount equal to or about 1-25 wt. % of the final product, and more preferably 5-20 wt. %, and still more preferably about 6-15 wt. %, and most preferably 6-10 wt. %.

In the exemplary embodiment of the insulation product 100 of FIG. 1, a facing layer 130, such as a non-woven, kraft or polyethylene film, is bonded to the first side 121 of the insulation mat. Some examples of facing layer material are non-woven glass or resin fibrous mats, polyethylene film and glass fiber scrim. Depending on the final application of the insulation product, the non-woven facing layer may be applied to both sides of the insulation mat or encapsulate the insulation mat if necessary. But, generally, at least one side of the insulation mat has a facing layer, which may or may not contain a vapor barrier.

FIG. 3 is a flow chart diagram of an exemplary process that may be employed in fabricating the insulation product 100 according to an embodiment of the present invention. A system for performing the various steps of FIG. 3 is described in commonly assigned U.S. patent application Ser. No. 10/851,535 filed May 21, 2004, published as U.S. Publication No. 2004/0217507 A1, entitled “Continuous Process For Duct Liner Production With Air Laid Process And On-Line Coating,” the entirety of which is hereby incorporated by reference herein.

At step 400, the bales of the fiber components of the duct liner are finely and individually opened through a bale opener. More specifically, the textile fibers, rotary fibers and bicomponent fibers are opened.

At step 402, the opened fibers are weighed continuously on-line by one or more conveyor scales to control the amount of each fibers being supplied to the process, thereby ensuring that the proper ratio of the fibers is provided for blending.

At step 404, the opened fibers are blended and transported to a fiber condenser by a pneumatic transport system which blends and transports the opened fibers in an air stream through a conduit.

At step 406, the opened fibers are condensed into a more compact fiber blend and formed into a continuously feeding sheet of mat by a feeder.

At step 408, a first sieve drum sheet former may be used to adjust the openness of the fiber blend in the fiber layer.

At step 410, the mat is again continuously weighed by a conveyor scale to ensure that the flow rate of the blended fibers through the fiber condenser and the sheet former is at a desired rate (e.g., g/ft²). The information from this conveyor scale is fed back to the first set of conveyor scale(s) associated with the bale openers to control the bale opener(s) operation. The conveyor scales ensure that a proper supply and demand relationship is maintained between the bale opener(s) and the fiber condenser and sheet former.

At step 411, before the last sheet former, a powder binder is applied on the fiber layer at a desired proportion through a feeding and weighing station as the continuously fed mat is leaving the conveyor scale.

At step 412, the fibers and powdered binder go through the last sheet former. A second sieve drum sheet former blends the powder binder into the fiber matrix of the mat and adjusts the openness of the fibers to a desired level. The primary blanket is thus formed.

At step 414, a facing layer is applied to the primary blanket. In embodiments, a non-woven scrim facing may be applied to at least one side of the mat before the curing and/or heating step.

At step 416, the mat is converted into a final mat by being cured and/or heated in a belt-furnace type curing or heating oven. The curing or heating oven is set at a temperature at or higher than the curing or thermosetting temperature of the selected powdered binder and at or higher than the melting temperature of the thermoplastic low-melting temperature component of the bicomponent fiber, but below the temperature of the high-melting temperature component of the bicomponent fiber. Preferably, the low-melting temperature thermoplastic component is heated at a sufficient temperature and for a sufficient time such that it completely melts, enabling it to serve as a binder and leaving the high-melting temperature fibrous component to contribute to the thermal, acoustical and/or structural properties of the insulation layer. In embodiments, the insulation layer is heated to a temperature of between about 125-250° C., and more preferably between about 170°-250°.

At step 418, the final mat is cooled.

At step 420, the edges of the final mat and the non-woven scrim facing is coated with an epoxy foam to provide a water resistant surface to the final duct liner, and then cooled.

At step 422, the coated final mat is cut to desired sizes and packaged for storage or shipping. At this step, the duct liner and/or the facing layer may be treated with an anti-microbial agent to resist growth of fungi or bacteria. The thickness of the final insulation mat 100 may be fabricated to be in the range of about 10 to 200 mm (about 0.5 to 8.0 inches) and preferably about 10 to 75 mm (about 0.5 to 3.0 inches). However, the fiber glass composite insulation material of the present invention may be used for a variety of types of insulation products and the final thickness, density, and gram weight of a particular insulation product may be determined by the levels of acoustic and/or thermal insulation that are desired or necessary for a particular application.

The insulation mat of the present invention is optimally suited for insulation product applications such as building insulation batts, duct liners, industrial high density insulation products such as duct boards, and OEM insulation products.

In exemplary embodiments, the insulation product is a duct liner having a thickness of between about 0.5-3″, and more preferably between about 0.5-2.0″, with a density of between about 1.5-3 lb/ft³. One exemplary ductliner comprises about 88 wt. % glass fiber with textile to rotary scrap fibers being provided in a ratio of about 3:2. The total content of the bicomponent fibers and phenolic powdered resin binder is about 12 wt. %, with 8% powdered binder and 4% bicomponent fiber. If it is assumed that about half of the weight of the bicomponent fiber is attributable to the low-melting temperature component, then the final insulation product of this embodiment has the following composition: 35.2 wt. % rotary scrap; 52.8 wt. % textile; 8 wt. % phenolic resin binder; 2 wt. % plastic binder (from the low-melting temperature component of the bicomponent fiber); and 2 wt. % plastic fiber (from the high-melting temperature component of the bicomponent fiber).

From the foregoing, exemplary ranges of these components are considered to be the following: 30-40 wt. % rotary scrap; 47-57 wt. % textile scrap; 6-10 wt. % phenolic resin binder; 1-3 wt. % plastic binder (from the low-melting temperature component of the bicomponent fiber); and 1-3 wt. % plastic fiber (from the high-melting temperature component of the bicomponent fiber).

When compared to ductliners consisting of rotary and textile fibers bonded with powdered resin binder, from observations and tests, the duct liner described above exhibits a more even surface and is softer in touch and feel while producing much less dust. The ductliner insulation product also exhibits improved thermal performance and increased thickness before the curing step 416. Essentially, the same R-value can be achieved with lower gram weights. Increased tensile strength was also noted. A control sample including 20 wt. % phenolic powdered binder exhibited a tensile strength of 86 lbs. A sample run under the same conditions but having 10 wt. % of the phenolic powdered binder replaced with 10 wt. % bicomponent fiber had a tensile strength of 132 lbs. This tensile strength was achieved at comparable average gram weight of 81.7 versus 82.6 for the 20 wt. % phenolic resin binder sample.

These results are also believed superior to products that replace the powdered binder component entirely or in large percentages with mono-component thermoplastic fibers (like nylon fibers, See U.S. Pat. No. 6,099,775 to Bargo et al.). When heating insulation layers, temperature gradients exist through the thickness of the layer leading to hot spots. It very difficult, if not impossible, to melt thermoplastic fiber in a controllable way. With the use of bicomponent fibers that have a low-melting temperature component (e.g., PE sheath) that is significantly lower than the high-melting temperature component (e.g., PET core), complete melting of the low temperature component can be achieved, leading to improved binder distribution and more effective melt bonds between fibers, while contributing structurally to the insulation mat through the intact high-melting temperature fiber component.

While the foregoing invention has been described with reference to the above embodiments, various modifications and changes can be made without departing from the spirit of the invention. Accordingly, all such modifications and changes are considered to be within the scope of the appended claims.

What is claimed is:

1. An insulation product, comprising:
a fibrous web including first fibers, rotary glass fibers, and textile glass fibers; and
a binder blended with said fibrous web, said binder bonding said fibers together to form the insulation product, said binder comprising a non-powderous thermoplastic binder component and a powdered binder component selected from the group consisting of thermoplastic and thermosetting resinous compositions.

2. The insulation product of claim 1, wherein said powdered binder component comprises a thermosetting resin powdered binder.

3. The insulation product of claim 2, wherein said thermosetting resin powdered binder is a phenolic resinous binder.

4. The insulation product of claim 1, wherein said first fibers are plastic fibers.

5. The insulation product of claim 1, wherein said first fibers have a melting temperature that is greater than a melting temperature of said non-powderous thermoplastic binder component.

6. The insulation product of claim 5, wherein the melting temperature of said first fibers is at least 250° C. and the melting temperature of said non-powderous thermoplastic binder component is less than or equal to about 160° C.

7. The insulation product of claim 1, wherein at least some of said rotary fibers comprise scrap fibers and at least some of said textile fibers comprise scrap fibers.

8. The insulation product of claim 1, wherein said textile and rotary glass fibers make up at least about 70 wt. % of the insulation product and said first fibers and binder make up less than or equal to about 30 wt. % of said insulation product.

9. The insulation product of claim 1, wherein:
said textile and rotary glass fibers make up at least 80 wt. % of the insulation product;
said powdered binder component makes up less than or equal to about 10 wt. % of the insulation product; and
said first fibers and said non-powderous thermoplastic binder component make up less than or equal to about 10 wt. % of the insulation product.

10. The insulation product of claim 1, wherein said textile glass fibers make up a greater or equal wt. % of the insulation product than said rotary glass fibers.

11. The insulation product of claim 1, wherein the powdered binder component is a powdered thermoplastic binder.

12. A method of forming an insulation product, comprising:
blending rotary glass fibers, textile glass fibers and bicomponent fibers with a powdered binder component, said bicomponent fibers comprising a high-melting temperature fibrous component and a low-melting temperature component;
forming said fibrous blend into an insulation layer; and
heating said insulation layer to a temperature sufficient to cure or melt said powdered binder component and melt said low-melting temperature component but below a temperature sufficient to melt said high temperature fibrous component, whereby said powdered binder component and low-melting temperature component, once cooled, bind to each other and also to said rotary glass fibers, textile glass fibers and high-melting temperature fibrous component together to form said insulation product.

13. The method of claim 12, wherein said powdered binder component comprises a thermosetting resin powdered binder.

14. The method of claim 13, wherein said thermosetting resin powdered binder is a phenolic resinous binder.

15. The method of claim 12, wherein said low-melting temperature component and high-melting temperature fibrous component of the bicomponent fibers are polymers.

16. The method of claim 12, wherein at least some of said rotary fibers comprise scrap fibers and at least some of said textile fibers comprise scrap fibers.

17. The method of claim 12, wherein the high-melting temperature fibrous component of said bicomponent fibers is at least 250° C. and the melting temperature of the low-melting temperature component of said bicomponent fibers is less than or equal to about 160° C.

18. The method of claim 12, wherein said textile and rotary glass fibers make up at least about 70 wt. % of the insulation product and said binder and bicomponent fibers makes up less than about 30 wt. % of said insulation product.

19. The method of claim 12, wherein:
said textile and rotary glass fibers make up at least about 80 wt. % of the insulation product;
said powdered binder component makes up less than or equal to about 15 wt. % of the insulation product; and
said bicomponent fibers make up less than or equal to about 10 wt. % of the insulation product.

20. The method of claim 12, wherein said textile glass fibers are provided to make up a greater wt. % of the insulation product than said rotary glass fibers.

21. An insulation product, comprising:
a blended mixture of rotary and textile glass fibers, high-melt temperature plastic fibers and a binder, said binder comprising a low-melt temperature thermoplastic binder component and a thermosetting binder component, said fibers being bonded together by the combined adhesion caused by heating said blended mixture to a temperature above the melt temperature of said thermoplastic binder and curing temperature of said thermosetting binder and below the melt temperature of said high-melt temperature plastic fibers and thereafter cooling said heated blended mixture to ambient temperature to form said insulation product, wherein at least some of the thermoplastic binder component and thermosetting binder component are also bound together.

22. The insulation product of claim 21, wherein:
said textile and rotary glass fibers make up at least 80 wt. % of the insulation product;
said thermosetting binder component makes up less than or equal to about 15 wt. % of the insulation product; and
said plastic fibers and thermoplastic binder component make up less than or equal to about 10 wt. % of the insulation product.

23. The insulation product of claim 22, wherein said textile glass fibers make up a greater or equal wt. % of the insulation product than said rotary glass fibers.

24. The insulation product of claim 21, wherein the melting temperature of said high-melt temperature plastic fiber is at least or about 100° C. greater that the melting temperature of said low-melt temperature thermoplastic binder component.

25. The insulation product of claim 21, wherein said thermosetting binder is a resinous powdered binder.

26. The insulation product of claim 25, wherein:
said textile and rotary glass fibers make up at least 80 wt. % of the insulation product;
said resinous powdered binder makes up less than or equal to about 10 wt. % of the insulation product; and
said plastic fibers and thermoplastic binder component make up less than or equal to about 6 wt. % of the insulation product.

27. The insulation product of claim 26, wherein said resinous powdered binder is a phenolic resinous powdered binder.
